(19) United States
(12) Patent Application Publication
(10) Pub. No.: US 2013/0032278 A1
(43) Pub. Date: Feb. 7, 2013

(54) GRAPHITE-CONTAINING MOLDED BODY AND METHOD FOR THE PRODUCTION THEREOF

(71) Applicants: Oswin Öttinger, Meitingen (DE); Rainer Schmitt, Augsburg (DE); Jürgen Bacher, Wertingen (DE); Sylvia Mechen, Meitingen (DE); Bastian Hudler, Rain (DE)

(72) Inventors: Oswin Öttinger, Meitingen (DE); Rainer Schmitt, Augsburg (DE); Jürgen Bacher, Wertingen (DE); Sylvia Mechen, Meitingen (DE); Bastian Hudler, Rain (DE)

(73) Assignee: SGL CARBON SE, WIESBADEN (DE)

(21) Appl. No.: 13/520,219

(22) PCT Filed: Dec. 31, 2010
(86) PCT No.: PCT/EP2010/070976

§ 371 Date: Sep. 28, 2012

Related U.S. Application Data
(63) Continuation-in-part of application No. 12/915,340, filed on Oct. 29, 2010.

(30) Foreign Application Priority Data
Dec. 31, 2009 (DE) 10 2009 055 440.8
Dec. 31, 2009 (DE) 10 2009 055 441.6
Dec. 31, 2009 (DE) 10 2009 055 442.4
Dec. 31, 2009 (DE) 10 2009 055 443.2
Dec. 31, 2009 (DE) 10 2009 055 444.0
Feb. 16, 2010 (DE) 10 2010 002 000.1
Feb. 26, 2010 (DE) 10 2010 002 434.1
Mar. 17, 2010 (DE) 10 2010 002 989.0
Sep. 20, 2010 (DE) 10 2010 041 085.3
Sep. 30, 2010 (DE) 10 2010 041 822.3

(51) Int. Cl. C08K 3/04; B29C 65/00; H01M 2/00; C08L 23/12; H01M 4/66; H01B 1/04; C09K 5/00; C09D 1/00; B29C 43/02; H01M 4/04

(52) U.S. Cl. 156/242; 264/109; 264/119; 264/105; 428/338; 252/502; 252/510; 252/71; 252/74; 252/511; 252/75; 106/286.8; 524/584

(57) ABSTRACT

A graphite-containing molded body is obtained by a method in which graphite particles are mixed with at least one solid additive to form a mixture which contains at least one inorganic additive, a mixture consisting of an inorganic additive and an organic additive, or more than 10 wt. % of an organic additive and the thus obtained mixture is subsequently compressed. The at least one additive which is used contains particles having an average diameter of between 1 and 500 μm, determined in accordance with the ISO 13320 standard.

The present invention relates to a graphite-containing molded body which is in particular suitable for use as a seal, as a structural material such as wall or ceiling cladding, as a bipolar plate for example for a redox flow cell, as a heat exchanger plate or as a heat exchanger tube, as well as a method for the production thereof.

Seals such as flat seals which are used for example in chemical apparatus must fulfil a plurality of requirements. In particular they must have a low permeability for liquids and gases and specifically in particular, as in the case of flat seals, in the plane of the seal. Apart from this, they must be characterized by a high tensile strength, by a high transverse strength, by a good thermal conductivity, by a good adaptability and by good dry sliding properties. For many applications, a high temperature resistance and a good resistance to aggressive chemicals are also essential.

As a result of the high temperature resistance in particular between −200° C. and +400° C., the exceptionally good dimensional stability under thermal loading, the good chemical resistance and the high rebound of graphite, such seals are frequently made of graphite. In order to increase the tightness of graphite, it has already been proposed to use liquid-impregnated graphite as sealing material, i.e. graphite whose pores have been at least partially closed by liquid impregnation or melt impregnation with a suitable impregnating agent. Solvent-free resins, for example, are used as impregnating agents where the graphite content of the sealing material here is usually 90 wt. % or more. In addition to the tightness, both the handling and also the scratch resistance of the material can also be improved by the impregnation.

A disadvantage of such materials produced by liquid impregnation however is that the impregnating agent is non-uniformly distributed, particularly in the depth direction or z direction of the material. Whereas a high degree of impregnation and a comparatively homogeneous impregnation is thus achieved in the surface areas of the material, the inner region of the material thus impregnated located between the surface regions exhibits no, or only a comparatively low or non-uniform, degree of impregnation. As a result, a seal made of such a material certainly exhibits a comparatively high impermeability for liquids and gases in its surface regions due to the surface impregnation; however, in the central region located between the surface regions this is comparatively permeable which is why these seals are only suitable to a certain extent for use as flat seals.

A similar problem occurs in building boards such as wall cladding panels or heat conduction plates based on graphite. In order to give such plates a sufficiently high strength, a sufficiently high stiffness and a sufficiently high abrasion strength, so that these can withstand the mechanical loads which occur when these are used as intended, these plates are usually also impregnated with a binder based on resin or thermoplastic by liquid impregnation. Here also a high degree of impregnation and a comparatively homogeneous impregnation is only achieved in the near-surface regions but not in the inner region lying between the surface regions, which is why these plates have a non-uniform stiffness and stability over their cross-section and the transverse strength of these plates varies very substantially.

Furthermore, the requirement profile for molded bodies designed for other applications such as, for example, for bipolar plates, current collectors and electrode materials, can comprise a high tensile strength, a high electrical conductivity or a low electrical resistance as well as a low contact resistance. Examples for such molded bodies are especially bipolar plates used in fuel cells, in redox flow cells or in lead acid batteries. The same or at least similar requirement profiles are also required for molded bodies used, for example, as a heat exchanger plate or as a heat exchanger tube.

In order to overcome at least a part of the aforesaid problems, materials have already been proposed, for example, for use as graphite-based seals, which are manufactured by mixing graphite and a solid ethylene tetrafluoroethylene copolymer together to close the pores of the graphite before a molded body to produce a seal is formed from the mixture thus produced. Although the properties of the sealing materials thus produced are better than those of liquid-impregnated sealing materials, the sum of the properties of these materials is still in need of improvement for many applications.

It is therefore the object of the present application to provide a graphite-containing molded body which not only has a high tensile strength, a high transverse strength, a high thermal conductivity, a good dry sliding property, a high temperature resistance and a good chemical resistance but which is also characterized over a wide temperature range and/or under a low surface pressure in particular by a particularly high impermeability for liquids and gases, and specifically depending on the particular application in particular in the plane, i.e. in the x-y direction of the seal and/or, as is important for example for the use as a bipolar plate or heat exchanger, perpendicular to the plane, i.e. in the z direction, by a low abrasion and by a low electrical resistance but nevertheless is also characterized by a good flexibility and which can be manufactured simply and cost-effectively.

According to the invention, this object is solved by providing a graphite-containing molded body which can be obtained by a method in which graphite particles are mixed with at least one solid additive to form a mixture which contains at least one inorganic additive, a mixture of at least one inorganic additive and at least one additive or more than 10 wt. % organic additive, and the mixture thus obtained is subsequently compressed, where the at least one additive used has a mean particle diameter (d₅₀) of between 1 and 500 μm, determined in accordance with ISO 13320.

This solution is based on the surprising finding that a molded body thus obtainable based on graphite and graphite having a specific particle size not only has a high degree of infiltration of pore-closing additive but that the pore-closing additive is additionally homogeneously distributed over all three dimensions and in particular in the depth direction of the molded body, i.e. in the z direction of the molded body. For this reason the molded body has the same properties in all three dimensions and in particular also in the plane of the molded body, i.e. in the x-y direction or the plane in which the molded body has its longest extension, and is characterized in particular by a high tensile strength in the x-y direction, a high strength in the z direction, a high thermal conductivity, a good dry sliding property, a high temperature resistance, a good chemical resistance, a high tightness and in particular surface tightness to liquids and gases and by a high stability and specifically in particular also when the surface pressure of the molded body is low. As a result of the homogeneous distribution of the additive or the additives over all three dimensions, it is in particular achieved that the additive is not only present in the near-surface regions of the molded body but in particular also in the inner or central region of the molded body located between the near-surface regions. This prevents the molded body from only having a high impermeability in its surface regions but gases or liquids are able to diffuse in the interior of the molded body. On the contrary, due to the homogeneous additive distribution a high impermeability is also achieved in the interior of the molded body in all dimensions and therefore in particular a high surface tightness.

It is also a particular advantage compared with the molded bodies known from the prior art that the molded body according to the invention can be produced rapidly, simply and cost-effectively and in particular by a continuous process in which a solid and preferably dry additive is added continuously by means of a screw conveyor, for example, to a gas stream containing graphite particles and thereby mixed and this mixture is then continuously guided through a roller in which the mixture is compressed.

As described, the molded body according to the invention is obtained by a method in which graphite particles are mixed with the at least one solid additive to form a mixture before the mixture thus obtained is then compressed. Within the framework of the present patent application, it is understood by this that in contrast to a liquid or melt impregnation, neither the graphite particles nor the additive nor the mixture containing graphite particles and additive are melted or sintered before compressing the mixture.

The specification that the at least one additive used has a mean particle diameter (d₅₀) between 1 and 500 μm means that all the additives used have a corresponding mean particle diameter (d₅₀) determined by the measurement method specified in ISO 13320.

In principle, particles based on all known graphites, i.e. for example particles of natural graphite or of synthetic graphite can be used as graphite starting material.

However, according to a particularly preferred embodiment of the present invention it is proposed that particles of expanded graphite are used as graphite particles. Expanded graphite is understood as graphite which, compared with natural graphite, is expanded for example, by a factor of 80 or more in the plane perpendicular to the hexagonal carbon layers. As a result of this expansion, expanded graphite is characterized by exceptionally good malleability and a good interlocking property, which is why this is particularly suitable for producing the molded body according to the invention. As a result of its likewise high porosity, expanded graphite can also be mixed very well with additive particles having a correspondingly small particle diameter and as a result of the degree of expansion, is easy to compress or compact. In order to produce expanded graphite having a worm-like structure, usually graphite such as natural graphite is mixed with an intercalation compound such as, for example nitric acid or sulphuric acid and heat-treated at an elevated temperature of, for example, 600 to 1200° C.

It is preferable to use expanded graphite which has preferably been produced from natural graphite having a mean particle diameter (d₅₀) of at least 149 μm and preferably of at least 180 μm determined in accordance with the measurement method and screen set specified in DIN 66165.

Particularly good results are obtained in this embodiment in particular using particles of expanded graphite having a degree of expansion of 10 to 1,400, preferably of 20 to 700 and particularly preferably of 60 to 100.

This substantially corresponds to expanded graphite having a bulk weight of 0.5 to 95 g/l, preferably of 1 to 25 g/l and particularly preferably of 2 to 10 g/l.

In a further development of the inventive idea, it is proposed to use graphite particles and in particular particles of expanded graphite having a mean particle diameter (d₅₀) of 150 to 3,500 μm, preferably of 250 to 2,000 μm and particularly preferably of 500 to 1,500 μm. These graphite particles can be mixed and compressed particularly well with particulate additives. In this case the mean diameter (d₅₀) of the graphite particles is determined in accordance with the measurement method and screen set specified in DIN 66165.

The mixture to be compressed preferably contains 50 to 99 wt. %, preferably 75 to 97 wt. % and particularly preferably 80 to 95 wt. % of graphite particles and preferably corresponding particles of expanded graphite.

According to a particularly preferred embodiment of the present invention, the molded body has an impermeability of less than 10⁻¹ mg/(s.m²), preferably of less than 10⁻² mg/(s·m²) and particularly preferably of less than 10⁻³ mg/(s·m²), measured in accordance with DIN EN 13555 at room temperature at a surface pressure of 20 MPa with helium as gas (40 bar internal pressure).

As described, the present invention comprises three fundamental embodiments, i.e. a graphite-containing molded body which in addition to graphite only contains inorganic additive, secondly a graphite-containing molded body which in addition to graphite only contains organic additive and specifically in a quantity of more than 10 wt. % and thirdly a graphite-containing molded body which in addition to graphite contains both inorganic additive and organic additive.

In a the first-mentioned embodiment in which the graphite-containing molded body only contains inorganic additive and no organic additive, this or the mixture to be compressed preferably contains 1 to 50 wt. %, particularly preferably 2 to 20 wt. % and quite particularly preferably 3 to 10 wt. % of one or more inorganic additives. As a result, not only a high impermeability is achieved but in particular also a good oxidation resistance up to 500° C. and a high tensile strength and overall an excellent mechanical stability of the molded body.

In a further development of the inventive idea it is proposed to use an inorganic additive which has a melting point of 1,800° C. maximum, preferably between 50 and 1,000° C. and particularly preferably between 100 and 650° C.

Good results are also achieved in particular if the at least one inorganic additive has a glass transition temperature of 1,800° C. maximum, preferably between 50 and 1,000° C. and particularly preferably between 100 and 650° C.

According to a further preferred variant of the present embodiment, the at least one inorganic additive has a sintering temperature between 50 and 950° C. and preferably between 100 and 600° C.

In principle, the molded body in this embodiment can contain fillers in addition to graphite and the inorganic additive but this is not necessary and also not preferred. Thus, the molded body according to the invention according to this embodiment preferably consists of the aforesaid quantity of inorganic additive and the remainder graphite.

The inorganic additive can comprise any arbitrary inorganic additive. Good results are obtained in particular if the inorganic additive is at least one glass former and/or at least one precursor of a glass former. With such materials in particular at comparatively high temperatures of for example 250° C. to 600° C., a high impermeability is achieved for liquid and gaseous substances.

Good results in this respect are achieved in particular if the at least one glass former and/or the at least one precursor of a glass former is a compound selected from the group consisting of phosphates, silicate, aluminosilicates, boroxides, borates and any mixtures of two or more of the aforesaid compounds.

According to a particularly preferred embodiment of the present invention, a phosphate is used as glass former because this can be distributed well in the entire cross-section of the molded body. Examples of particularly suitable phosphates are those selected from the group consisting of aluminium dihydrogen phosphate, polyphosphate, hydrogen phosphate, calcium phosphates and aluminium phosphates.

Consequently, the inorganic additive is preferably selected with regard to its chemical nature and quantity used so that the molded body is impermeable in a temperature between 250 and 600° C. and in particular in a temperature range between 300 and 550° C., where impermeable is understood in the sense of the present invention such that at a surface pressure of 32 MPa the molded body has a leakage rate of less than 1×10⁻⁴ mbar·l/s·m (1.1 bar helium) in accordance with the Technical Guidelines on Air Quality Control following aging for 48 hours at 300° C. or preferably following aging for 48 hours at 400° C.

In a further development of the inventive idea, it is proposed that the inorganic additive or the inorganic additives in the mixture to be compressed have a mean particle diameter (d₅₀) determined in accordance with ISO 13320 of 0.5 to 300 μm and preferably of 1 to 50 μm.

It is further preferred that the molded body containing only inorganic additive according to this embodiment has a density of at least 0.7 g/cm³ and preferably a density of 1.0 to 1.4 g/cm³.

According to a second quite particularly preferred embodiment of the present invention, the molded body according to the invention only contains organic additive but no inorganic additive. Good results in particular with regard to a desired impermeability but also in regard to a high tensile strength and mechanical stability are achieved in particular if the mixture to be compressed or the molded body contains more than 10 to 50 wt. %, preferably 10 to 25 wt. % and particularly preferably 10 to 20 wt. % of one or more organic additives. By adding more than 10 wt. % of organic additive, a molded body having a very high tensile strength and having a high impermeability in particular in the z direction of the molded body is obtained. Apart from this, the addition of a comparatively large amount of organic additive makes shaping easier and leads to a better weldability of the molded body with, for example, another molded body according to the invention, with a graphite film, metal film, a metal sheet or a metal block or with a textile fabric such as, for example, with felt. In addition, a better sliding friction as well as a higher transverse strength than when adding smaller amounts of organic additive is achieved.

In principle, the molded body in this embodiment can contain fillers in addition to the graphite and the organic additive but this is not necessary and also not preferred. Thus, the molded body according to the invention according to this embodiment preferably consists of the aforesaid quantity of organic additive and the remainder graphite.

In principle, any arbitrary organic additive can be used as organic additive. Good results are obtained in particular if the organic additive is a polymer selected from the group consisting of thermoplastics, thermosetting plastics, elastomers and arbitrary mixtures thereof. With such materials in particular at comparatively low temperatures of for example −100° C. to 300° C., a high impermeability of the molded body is achieved for liquid and gaseous substances.

Examples of suitable polymers are silicone resins, polyolefins, epoxide resins, phenol resins, melamine resins, urea resins, polyester resins, polyether etherketones, benzoxazines, polyurethanes, nitrile rubbers, such as acrylonitrile butadiene styrene rubber, polyamides, polyimides, polysulphones, polyvinylchloride and fluoropolymers such as polyvinylidene fluoride, ethylene tetrafluoroethylene copolymers and polytetrafluoroethylene and mixtures or copolymers of two or more of the aforesaid compounds.

According to a particularly preferred variant of this embodiment, the organic additive or the organic additives is or are exclusively fluorine-free polymers. This has surprisingly proved particularly advantageous within the framework of the present invention for the balance of all the requisite properties such as high tensile strength, high transverse strength, high thermal conductivity, good dry sliding property, high temperature resistance, good chemical resistance and high impermeability to liquids and gases.

Examples of suitable fluorine-free polymers are polymers selected from the group consisting of silicone resins, polyolefins, epoxide resins, phenol resins, melamine resins, urea resins, polyester resins, polyether etherketones, benzoxazines, polyurethanes, nitrile rubbers, polyamides, polyimides, polysulphones and any mixtures or copolymers of two or more of the aforesaid compounds. Whereas examples of particularly suitable polyolefins are polyethylene and polypropylene, acrylonitrile butadiene styrene rubber is particularly suitable as nitrile rubber. In particular, due to the addition of silicone resins, a better tightness and in particular a significantly better surface tightness is achieved compared to the addition of fluoropolymers.

Consequently, the organic additive is preferably selected with respect to its chemical nature and quantity used such that the molded body is impermeable in a temperature range between −100 and 300° C. and in particular in a temperature range between −20 and 250° C. and quite particularly at room temperature, where impermeable is understood in the sense of the present invention such that the molded body has an impermeability of less than 10⁻¹ mg/(s·m), preferably of less than 10⁻² mg/(s·m) and particularly preferably of less than 10⁻³ mg/(s·m), measured in accordance with DIN EN 13555 in the aforesaid temperature ranges at a surface pressure of 20 MPa with helium as gas (40 bar internal pressure).

In particular, in molded bodies designed for applications such as, for example, as bipolar plates or as heat exchanger plates in which primarily a high impermeability in the z direction is required, it is preferred that in a temperature range between −100 and 300° C. and in particular in a temperature range between −20 and 250° C. the molded body has an impermeability in the z direction of less than 10⁻¹ mg/(s·m²), preferably of less than 10⁻² mg/(s·m²) and particularly preferably of less than 10⁻³ mg/(s·m²), measured in accordance with DIN 28090-1 in the aforesaid temperature ranges at a surface pressure of 20 MPa with helium as gas (1 bar helium test gas internal pressure) in a measurement apparatus based on DIN 28090-1 at room temperature.

As a result of the addition of an organic additive, it is easily possible to provide the graphite-containing molded body such that this has a tensile strength measured in accordance with DIN ISCO 1924-2 of 10 to 35 MPa and preferably of 15 to 25 MPa.

In a further development of the inventive idea, it is proposed that the organic additive or the organic additives in the mixture to be compressed have a mean particle diameter (d₅₀) determined in accordance with ISO 13320 of 1 to 150 μm, preferably of 2 to 30 μm and particularly preferably of 3 to 10 μm.

It is further preferred that the molded body containing only organic additive according to this embodiment has a density of at least 1.0 g/cm³, preferably a density of 1.2 to 1.8 g/cm³ and particularly preferably a density of 1.4 to 1.7 g/cm³.

According to a third quite particularly preferred embodiment of the present invention, the molded body according to the invention contains organic additive and inorganic additive. A particular advantage of this embodiment is that due to the combination of organic additive and inorganic additive, a high impermeability of the molded body to liquids and gases is achieved over a very wide temperature range from comparatively very low to comparatively very high temperatures. This can be achieved, for example, by selecting an inorganic additive and an organic additive where at a temperature in the range of the temperature and in particular just below the temperature at which the organic additive is decomposed, for example, by pyrolysis, combustion or a decomposition reaction, the inorganic additive begins to contribute to a compression of the molded body, for example, initiated by a sintering or melting process, and to thus take over the role of the organic additive at a higher temperature.

In order to achieve particularly good results in this respect, it is proposed in a further development of the inventive idea that the mixture to be compressed or the molded body contains 1 to 25 wt. % of inorganic additive and 1 to 25 wt. % of organic additive and preferably 3 to 20 wt. % and 5 to 15 wt. % of organic additive.

In principle, the molded body in this embodiment can contain fillers in addition to the graphite, the inorganic additive and the organic additive but this is not necessary and also not preferred. Thus, the molded body according to the invention according to this embodiment preferably consists of the aforesaid quantity of organic additive, inorganic additive and the remainder graphite.

In particular, the additives already mentioned hereinbefore for the two other quite particularly preferred embodiments of the present invention are suitable as inorganic additive and as organic additive. Particularly good results primarily with regard to an excellent surface tightness are achieved in particular with the combination of glass former as inorganic additive and silicone resin as organic additive. The inorganic and organic additives preferably have the mean particle diameter mentioned hereinbefore for the two other quite particularly preferred embodiments.

The organic additive and the inorganic additive are preferably selected with respect to their chemical nature and quantities used such that the molded body is impermeable in a temperature range between −100 and 600° C. and in particular in a temperature range between −20 and 550° C. where impermeable is understood in the sense of the present invention such that the molded body has an impermeability of less than 10⁻¹ mg/(s·m) measured in accordance with DIN EN 13555 in a temperature range of −100 to 300° C. at a surface pressure of 20 MPa with helium as gas (40 bar internal pressure) and at a surface pressure of 32 MPa the molded body has a leakage rate of less than 1×10⁻⁴ mbar·l/s·m (1.1 bar helium) measured in accordance with the Technical Guidelines on Air Quality Control following aging for 48 hours in a temperature range of 300° C. to 600° C. The molded body preferably has an impermeability of less than 10⁻² mg/(s·m) and particularly preferably of less than 10⁻³ mg/(s·m) measured in accordance with DIN EN 13555 in a temperature range between −100 and 600° C. and preferably between −20 and 550° C. at a surface pressure of 20 MPa with helium as gas (40 bar internal pressure).

In a further development of the inventive idea, it is proposed that the molded body containing both the organic and the inorganic additive according to this embodiment has a density of at least 0.7 g/cm³ and preferably a density of 1.0 to 1.8 g/cm³.

According to another preferred embodiment of the present invention, the molded body is configured to be at least substantially flat and specifically for example, as a plate, strip or film. Molded bodies configured to be substantially flat are understood within the framework of the present invention as specially shaped molded bodies such as sealing rings for example. The advantage of a high surface tightness can be utilized particularly well for flat molded bodies.

In order to increase the mechanical stability of the molded body, this can be provided with a two- or three-dimensionally structured reinforcement. In particular structured plates such as perforated plates, for example, are suitable for this purpose.

A further subject matter of the present invention is a method for producing a molded body described previously, which comprises the following steps:

a) mixing graphite particles with at least one solid organic additive to form a mixture, which contains at least one inorganic additive, a mixture of at least one inorganic additive and at least one organic additive or more than 10 wt. % of organic additive, where the at least one additive used has a mean particle diameter (d₅₀) determined in accordance with ISO 13320 between 1 and 500 μm and
b) compressing the mixture obtained in step a).

The method according to the invention is preferably carried out continuously in order to thus produce the molded bodies according to the invention rapidly, easily and cost-effectively.

The continuous procedure can be executed, for example, in a pipeline system in which the mixing according to process step a) is carried out such that a solid additive is fed, for example to a graphite-particle-containing gas stream by means of a screw conveyor and the gas stream containing mixed graphite particles and organic additive thus obtained is passed through a roller for compression according to process step b). Thus, not only the graphite particles and the additive can be mixed together rapidly and simply but in particular mixed gently, i.e. without major mechanical stressing so that any crushing and grinding of the solid particles during mixing, such as necessarily occurs when mixing in a static or dynamic agitator for several minutes or even hours, is avoided. This promotes the preceding advantageous properties of the molded body according to the invention, primarily a high tensile strength and a high transverse strength.

In the method according to the invention, no mixing in a static or dynamic agitating device for more than 5 minutes, particularly for more than 20 minutes and in particular for more than 1 hour is therefore carried out before the compressing.

According to another preferred embodiment of the present invention, the mixture containing graphite particles and additive is melted and/or sintered during the compression or after the compression according to process step b). Within the framework of the present invention, it was surprisingly found that by this means the impermeability of the molded body to liquids and gases can be further increased. Without wishing to be bound to a theory, it is considered that the bonding of the graphite particles to the additive particles is improved by such melting or sintering and due to the thin thin-liquid additive, additional pores are closed and contact points produced.

A separate shaping step can be carried out for the final shaping in which the molded body is formed for example, by reforming, profiling, joining, hot pressing, thermo-reforming, folding back, deep drawing, embossing or stamping.

In this case, the shaping step can advantageously be carried out before the final compression step. For example, it can be advantageous when using the molded body as a seal to deform the molded body by clamping between two parts to be sealed and then finally compressing, for example, by application of temperature. However, a pre-compression can be carried before the deformation, for example, by pressing.

In addition, the molded body can be heated in a mould whereby specific profiles, shapes, corrugations and/or embossings are produced. The additive stabilizes these shapes and prevents the back deformation known from conventional graphite films. The mechanical load-bearing capacity produced by the present invention allows such methods to be used for the first time.

Finally, the present invention relates to the use of a graphite-containing molded body described previously as a sealing element, as a bipolar plate of a fuel cell, a redox flow battery, as a heat conduction film, as a molded part in the construction area, in particular as wall cladding, ceiling cladding or heat conduction plate, as a current collector in lead acid batteries or in corresponding hybrid systems, as a film or fin in PCM graphite storage devices, as lining material, as contact element, as electrode material for battery systems, as a heat distributing element, as surface heater, as material for winding graphite tubes with the individual layers being weldable, as stuffing box packing, as packings for chemical columns, as heat exchanger plate or as heat exchanger tube.

For the use of the molded body according to the invention as a bipolar plate in a redox flow battery, the molded body is preferably configured as a film or plate having a thickness of 0.02 to 1.5 mm, particularly preferably having a thickness of 0.2 to 1 mm and quite particularly preferably having a thickness of 0.5 to 0.8 mm. Thicker plates can be produced for example by pressing, adhesive bonding, hot gluing of two individual molded bodies. This is possible with or without pressure and by using adhesives, adhesion promoters or by the additive present in the molded body. The direct weldability of two molded bodies is particularly preferred.

In the use of the molded body according to the invention as a bipolar plate, it can be particularly advantageous to join the molded body according to the invention to a felt which preferably contains graphite and/or carbon and particularly preferably graphite and/or carbon fibers. In this case, the join can be made, for example, by adhesive bonding. In particular, a conductive adhesive can be used such as an adhesive filled with silver particles, carbon particles or graphite particles. Such a connection can also be made by melting or by sintering with a plastic, in particular a polymer described previously for the organic additive. In the simplest case therefore, a felt is joined thermally to a molded body according to the invention without further materials.

In the embodiment described previously the density of the felt is preferably 0.01 to 0.2 g/cm³. At the same time, the electrical resistivity measured in the felt plane is preferably between 0.5 and 15 Ohm mm and the electrical resistivity measured perpendicular to the felt plane is preferably between 2 and 20 Ohm mm. These values relate to a compression of the felt of 20 to 30%. Under stronger or weaker compression, the electrical resistivity is accordingly lower or higher. The specific surface area of the felt is preferably between 0.2 and 300 m²/g.

Particularly in the use of the molded body according to the invention as a molded part in the construction area, in particular as wall cladding, ceiling cladding or heat conduction plate, it has proved advantageous to provide the molded body as plastically deformable and for example in the form of a plate so that the molded body can be molded simply at the installation site to predefined contours of walls or ceilings, for example, edges, curves, corners, friezes and the like. The plate can then be finally solidified at the installation site, for example, by heating the still plastically deformable plate in the installed state.

In principle, the molded body according to the invention can be used before or after a complete curing or before or after a melting and/or sintering of the additive.

Alternatively to this, it is also possible to use the molded body after a partial curing, melting and/or sintering of the additive, where the final curing, melting and/or sintering of the additive is accomplished for example by the use at the operating temperature. In this embodiment, for example, a high tightness of the molded body only occurs in the course of use. This has the advantage that during installation, malleability is possible in order to achieve a better matching of the molded body, for example, to parts to be connected tightly.

A further subject matter of the present invention is the use of a graphite-containing molded body described previously in a method for joining the molded body to another molded body, where the other molded body can, for example, be a graphite film, a metal film, a metal sheet, a metal block, a textile fabric, preferably a felt body or a molded body described previously. The joining of the molded bodies thereby takes place without additional adhesive. Such an adhesive is dispensable in the use according to the invention since the organic additive contained in the molded body acts as binder and thus allows welding of the two bodies.

The present invention is described hereinafter merely as an example with reference to advantageous embodiments and with reference to the appended drawings.

In the figures:

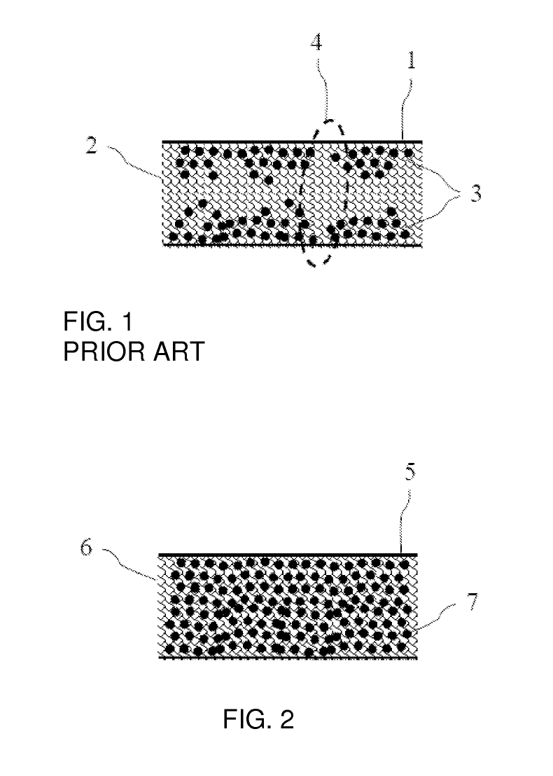

FIG. 1 shows a graphite-containing molded body according to the prior art and

FIG. 2 shows a graphite-containing molded body according to one exemplary embodiment of the present invention.

FIG. 1 shows a schematic cross-section of a graphite-containing molded body 1 configured as a plate according to the prior art. This molded body 1 contains compressed, expanded graphite 2 and a liquid binder 3, where the binder 3 has been introduced subsequently into the molded body 1 by liquid or melt impregnation from the lateral surfaces of the molded body 1. As a result of introducing the binder 3 by liquid or melt impregnation, this has only penetrated non-uniformly and primarily superficially into the molded body 1 which is why particularly the inner region lying between the surface regions, such as for example, the region 4 lying in the oval dashed border contains only a little binder 3 or is almost binder-free. As a result, the properties of the molded body 1, in particular the mechanical strength and the tightness, of the molded body 1 vary primarily in the depth direction or z direction, where the inner region of the molded body 1 lying between the surface regions has a poorer tightness and inferior mechanical properties than the surface regions of the molded body 1.

The molded body 5 according to the present invention shown in FIG. 2 consists of particles 6 of expanded graphite configured in a known manner in a worm or concertina shape and of additive particles 7. Unlike the molded body 1 according to the prior art shown in FIG. 1, the additive particles 7 are distributed uniformly in all dimensions of the molded body 5 in the molded body 5 according to the invention and specifically in particular in the inner region of the molded body 5 lying between the surface regions.

In order to produce the molded body 5 according to the invention shown in FIG. 2, the graphite particles 6 are firstly mixed homogeneously with the solid additive particles 7 before the mixture thus produced was compressed and formed into the desired shape.

The present invention is described further hereinafter with reference to examples which explain but do not restrict this invention.

### EXAMPLES

### Example 1

Expanded graphite having a bulk weight of 3.5 g/l was mixed with a silicone resin powder, i.e. Silres MK from Wacker Chemie AG in Burghausen, Germany to form a mixture containing 80 wt. % expanded graphite and 20 wt. % silicone resin powder and was then mixed in a container for 1 minute.

The mixture thus obtained was then transferred to a steel tube having a diameter of 90 mm, pressed by a pressure piston through its own body weight and removed as a perform having a density of about 0.07 g/cm³. The perform was then compressed with a press to the desired film thickness of 1 mm and the doped film thus obtained was conditioned at 180° C. for 60 minutes in order to melt the plastic.

Two of these films were pressed with a perforated plate having a thickness of 0.1 mm and the leakage rate of this molded body was determined in accordance with DIN EN 13555 using helium as test gas (40 bar internal pressure).

The specific surface pressures which are required to achieve a certain leakage class are given in the following Table 1.

### Comparative Example 1

Two graphite films were produced according to the method described for Example 1, except that only expanded graphite and no additive was used for the manufacture.

Two of these films were pressed with a perforated plate having a thickness of 0.1 mm and the leakage rate of this molded body was determined in accordance with DIN EN 13555 using helium as test gas (40 bar internal pressure).

The values obtained are summarized in the following Table 1

TABLE 1

| | Thickness | Density | Thickness of | | |
|---|---|---|---|---|---|
| | of film | of film | reinforcement | L_{0.01} | L_{0.001} |
| Sample | [mm] | [g/cm³] | [mm] | [MPa] | [MPa] |
| Example 1 | 1 | 1 | 0.1 | 12 | 21 |
| Comparative | 1 | 1 | 0.1 | 15 | 33 |
| Example 1 | | | | | |

It can be clearly seen that the impermeability is improved by the additive. As a result of the addition of additive, a certain tightness level is achieved at significantly lower surface pressures.

### Examples 2 and 3

Expanded graphite having a bulk weight of 3.5 g/l was mixed with an inorganic filler, i.e. ammonium dihydrogen phosphate (NH₄H₂PO₄) in Example 2 and boron carbide (B₄C) in Example 3 to form a mixture containing 90 wt. % expanded graphite and 10 wt. % inorganic filler and was then mixed in a container for 1 minute.

The mixture thus obtained was then transferred to a steel tube having a diameter of 90 mm, pressed by a pressure piston through its own body weight and removed as a perform having a density of about 0.07 g/cm³. The perform was then compressed with a press to the desired film thickness of 1 mm and the doped film thus obtained was conditioned at 180° C. for 60 minutes.

For both samples the leakage rate was measured in accordance with DIN 28090-1 with nitrogen as test gas and 32 MPa surface pressure relative to a weight per unit area of the molded body of 2,000 g/m².

The values obtained are summarized in the following Table 2.

### Comparative Example 2

A graphite film was produced according to the method described for Examples 2 and 3 except that only expanded graphite and no additive was used to produce this.

For the sample the leakage rate was measured in accordance with DIN 28090-1 with nitrogen as test gas and 32 MPa surface pressure relative to a weight per unit area of the molded body of 2,000 g/m².

The values obtained are summarized in the following Table 2.

TABLE 2

| | | Quantity | | | |
|---|---|---|---|---|---|
| | Density | of | | Leakage | Compressive |
| | of film | filler | Type of | rate | strength |
| Sample | [g/cm³] | [wt. %] | filler | [ml/min] | [MPa] |
| Comp. | 1 | 0 | — | 2.9 | 142 |
| Ex. 1 | | | | | |
| Ex. 2 | 1 | 10 | NH₄H₂PO₄ | 0.6 | 188 |
| Ex. 3 | 1 | 10 | B₄C | 1.8 | 151 |

Comp. Ex.: Comparative example
Ex.: Example

It can be clearly seen from the values reproduced in Table 2 that the leakage rate of the molded body is considerably reduced by adding the inorganic additive. In addition, following the formation of the glass-like network now present in the entire film composite, the compressive strength is positively influenced.

### Examples 4 to 7

Expanded graphite having a bulk weight of 3.5 g/l was mixed with ammonium dihydrogen phosphate (NH₄H₂PO₄) for Examples 4 and 5 and ammonium hydrogen phosphate (NH₄)₂HPO₄ for Examples 6 and 7 as inorganic filler to form a mixture containing 95 wt. % expanded graphite and 5 wt. % inorganic filler which was then mixed in a container for 1 minute.

The mixtures thus obtained were then transferred to a steel tube having a diameter of 90 mm, pressed by a pressure piston through its own body weight and removed as a perform having a density of about 0.07 g/cm³. The perform was then compressed with a press to the desired film thickness of 1 mm and the doped film thus obtained was conditioned under various conditions which are summarized in the following Table 3.

For all the samples the leakage rate was measured in accordance with DIN 28090-1 with nitrogen as test gas and 32 MPa surface pressure relative to a weight per unit area of the molded body of 2,000 g/m².

The values obtained are summarized in the following Table 3.

### Comparative Example 3

A graphite film was produced according to the method described for Examples 4 to 7 except that only expanded graphite and no additive was used to produce this.

For the sample the leakage rate was measured in accordance with DIN 28090-1 with nitrogen as test gas and 32 MPa surface pressure relative to a weight per unit area of the molded body of 2,000 g/m².

The values obtained are summarized in the following Table 3.

TABLE 3

| | | Quantity | | | |
|---|---|---|---|---|---|
| | Density | of | | | Leakage |
| | of film | filler | Type of | | rate |
| Sample | [g/cm³] | [wt. %] | filler | Conditioning | [ml/min] |
| Comp. | 1 | 0 | — | — | 1.5 |
| Ex. 3 | | | | | |
| Ex. 4 | 1 | 5 | NH₄H₂PO₄ | 1 h/300° C. | 0.9 |
| Ex. 5 | 1 | 5 | NH₄H₂PO₄ | 1 h/600° C. | 0.3 |
| Ex. 6 | 1 | 5 | (NH₄)₂HPO₄ | 1 h/300° C. | 1.5 |
| Ex. 7 | 1 | 5 | (NH₄)₂HPO₄ | 1 h/600° C. | 0.6 |

Comp. Ex.: Comparative example
Ex.: Example

It can be clearly seen from the values reproduced in Table 3 that the leakage rate of the molded body is considerably reduced by adding the inorganic additive and this can be additionally influenced by the type of conditioning.

### Example 8

Expanded graphite having a bulk weight of 3.5 g/l was mixed with a polypropylene powder, i.e. with Licocene PP 2602 from Clariant, Germany to form a mixture containing 80 wt. % expanded graphite and 20 wt. % polypropylene polymer powder and was then mixed in a container for 1 minute.

The mixture thus obtained was then transferred to a steel tube having a diameter of 90 mm, pressed by a pressure piston through its own body weight and removed as a perform having a density of about 0.07 g/cm³. The perform was then compressed with a press to the desired film thickness of 0.6 mm and the doped film thus obtained was aged at 180° C. for 60 minutes to melt the plastic.

The impermeability of the molded body in the z direction was determined at a surface pressure of 20 MPa with helium as gas (1 bar helium gas internal pressure) in a measurement apparatus based on DIN 28090-1 at room temperature. The tensile strength of the graphite-containing molded body was determined in accordance with DIN ISO 1924-2. The values obtained are summarized in the following Table 4.

### Comparative Example 4

A molded body in the form of a graphite film was produced according to the method described for Example 8 except that only expanded graphite and no additive was used to produce this.

The impermeability of the molded body in the z direction was determined at a surface pressure of 20 MPa with helium as gas (1 bar helium gas internal pressure) in a measurement apparatus based on DIN 28090-1 at room temperature. The tensile strength of the graphite-containing molded body was determined in accordance with DIN ISO 1924-2. The values obtained are summarized in the following Table 4.

TABLE 4

| | Thickness | Density of | | Tensile |
|---|---|---|---|---|
| | of film | film | Impermeability | strength |
| Sample | [mm] | [g/cm³] | [mg/(s · m²)] | [MPa] |
| Comp. | 0.6 | 1.7 | 1.10⁻² | 15 |
| Ex. 4 | | | | |
| Ex. 8 | 0.6 | 1.7 | 1.10⁻³ | 25 |

Comp. Ex.: Comparative example
Ex.: Example

It can be clearly seen that by adding the organic additive to the graphite film, its impermeability is improved particularly in the z direction and the tensile strength can be increased significantly compared with an additive-free graphite-containing molded body.

### REFERENCE LIST

1 Molded body according to the prior art
2 (Expanded) graphite
3 Binder
4 Area of the molded body
5 Molded body according to the present invention
6 Particle of (expanded) graphite
7 Additive particle

1-19. (canceled)

20. A graphite-containing molded body, comprising:
graphite particles;
at least one solid additive mixed with said graphite particles to form a mixture, said mixture containing one of at least one inorganic additive, a mixture of at least one inorganic additive and at least one additive, or at least 10 wt. % of an organic additive, said mixture being subsequently compressed, said at least one solid additive having a mean particle diameter of between 1 and 500 μm determined in accordance with ISO 13320.

21. The molded body according to claim 20, wherein said graphite particles, said at least one solid additive and said mixture produced therefrom are not melted and not sintered before compressing.

22. The molded body according to claim 20, wherein said graphite particles are particles from expanded graphite produced from natural graphite having a mean particle diameter of at least 149 μm determined in accordance with a measurement method and screen set specified in DIN 66165.

23. The molded body according to claim 22, wherein said particles of said expanded graphite have a bulk weight of 0.5 to 95 g/l.

24. The molded body according to claim 20, wherein the graphite-containing molded body has an impermeability of less than 10⁻¹ mg/(s·m) measured at a surface pressure of 20 MPa with helium as a gas at 40 bar internal pressure in accordance with DIN 28090-1 at room temperature.

25. The molded body according to claim 20, wherein the graphite-containing molded body has an impermeability in a z direction of less than 10⁻¹ mg/(s·m²), measured at a surface pressure of 20 MPa with helium as a gas, at 1 bar helium test gas internal pressure, measured in a measurement apparatus based on DIN 28090-1 at room temperature.

26. The molded body according to claim 20, wherein said mixture to be compressed contains 1 to 50 wt. % of said at least one inorganic additive.

27. The molded body according to claim 20, wherein said at least one inorganic additive has at least of a melting point or a glass transition temperature of 1,800° C. maximum.

28. The molded body according to claim 20, wherein said mixture to be compressed contains 10 to 50 wt. % of said at least one organic additive.

29. The molded body according to claim 28, wherein said mixture to be compressed only contains at least one fluorine-free polymer as said organic additive.

30. The molded body according to claim 29, wherein said mixture to be compressed contains as said organic additive at least one polymer selected from the group consisting of silicone resins, polyolefins, polyethylene, polypropylene, epoxide resins, phenol resins, melamine resins, urea resins, polyester resins, polyether etherketones, benzoxazines, polyurethanes, nitrile rubbers, acrylonitrile butadiene styrene rubber, polyamides, polyimides, polysulphones, any mixtures of at least two of said aforesaid compounds and copolymers of at least two of said aforesaid compounds.

31. The molded body according to claim 20, wherein said organic additive has a mean particle diameter of 1 to 150 μm determined in accordance with ISO 13320.

32. The molded body according to claim 20, wherein said mixture to be compressed contains said at least one inorganic additive and said at least one organic additive.

33. The molded body according to claim 20, wherein said graphite particles are particles of expanded graphite produced from natural graphite having a mean particle diameter of at least 180 μm determined in accordance with a measurement method and screen set specified in DIN 66165.

34. The molded body according to claim 22, wherein said particles of said expanded graphite have a bulk weight of 1 to 25 g/l.

35. The molded body according to claim 22, wherein said particles of said expanded graphite have a bulk weight of 2 to 10 g/l.

36. The molded body according to claim 20, wherein the graphite-containing molded body has an impermeability of less than 10⁻² mg/(s·m) measured at a surface pressure of 20 MPa with helium as a gas at 40 bar internal pressure, in accordance with DIN 28090-1 at room temperature.

37. The molded body according to claim 20, wherein the graphite-containing molded body has an impermeability of less than 10⁻³ mg/(s·m) measured at a surface pressure of 20 Mpa with helium as a gas at 40 bar internal pressure in accordance with DIN 28090-1 at room temperature.

38. The molded body according to claim 20, wherein the graphite-containing molded body has an impermeability in a z direction of less than 10⁻² mg/(s·m²), measured at a surface pressure of 20 Mpa with helium as a gas, at 1 bar helium test gas internal pressure, measured in a measurement apparatus based on DIN 28090-1 at room temperature.

39. The molded body according to claim 20, wherein the graphite-containing molded body has an impermeability in a z direction of less than 10⁻³ mg/(s·m²), measured at a surface pressure of 20 Mpa with helium as a gas, at 1 bar helium test gas internal pressure, measured in a measurement apparatus based on DIN 28090-1 at room temperature.

40. The molded body according to claim 20, wherein said mixture to be compressed contains 2 to 20 wt. % of said at least one inorganic additive.

41. The molded body according to claim 20, wherein said mixture to be compressed contains 3 to 10 wt. % of said at least one inorganic additive.

42. The molded body according to claim 20, wherein said at least one inorganic additive has at least of a melting point or a glass transition temperature between 50 and 1,000° C.

43. The molded body according to claim 20, wherein said at least one inorganic additive has at least of a melting point or a glass transition temperature between 100 and 650° C.

44. The molded body according to claim 20, wherein said mixture to be compressed contains 10 to 25 wt. % of said at least one organic additive

45. The molded body according to claim 20, wherein said mixture to be compressed contains 10 to 20 wt. % of said at least one organic additive

46. The molded body according to claim 20, wherein said organic additive has a mean particle diameter of 2 to 30 μm determined in accordance with ISO 13320.

47. The molded body according to claim 20, wherein said organic additive has a mean particle diameter of 3 to 10 μm determined in accordance with ISO 13320.

48. The molded body according to claim 32, wherein the molded body has an impermeability of less than 10⁻¹ mg/(s·m) measured in accordance with DIN EN 13555 in a temperature range of −100 to 300° C. at a surface pressure of 20 Mpa with helium as a gas, at 40 bar internal pressure, and at a surface pressure of 32 Mpa, the molded body has a leakage rate of less than 1×10⁻⁴ mbar·l/s·m, at 1.1 bar helium, measured in accordance with Technical Guidelines on Air Quality Control following aging for 48 hours in a temperature range of 300° C. to 600° C.

49. The molded body according to claim 20, wherein the molded body only contains said inorganic additive and has a density of 0.7 to 1.4 g/cm³.

50. The molded body according to claim 20, wherein the molded body only contains said organic additive and has a density of 1.0 to 1.8 g/cm³.

51. The molded body according to claim 20, wherein the molded body contains said inorganic and organic additive and has a density of 0.7 to 1.8 g/cm³.

52. A method for producing a molded body, which comprises the following steps of:
a) mixing graphite particles with at least one solid additive to form a mixture containing one of at least one of an inorganic additive, a mixture of at least one inorganic additive and at least one organic additive, or at least 10 wt. % of an organic additive, wherein the at least one solid additive having a mean particle diameter determined in accordance with ISO 13320 between 1 and 500 μm; and
b) compressing the mixture obtained in step a).

53. The method according to claim 52, which further comprises performing a shaping step in which the molded body is formed by one of reforming, profiling, joining, hot pressing, thermo-reforming, folding back, deep drawing, embossing or stamping.

54. A method of using a graphite-containing molded body, which comprises the steps of:
providing the graphite-containing molded body containing graphite particles, at least one solid additive mixed with the graphite particles to form a mixture, the mixture containing one of at least one inorganic additive, a mixture of at least one inorganic additive and at least one additive, or at least 10 wt. % of an organic additive, the mixture being subsequently compressed, the at least one solid additive having a mean particle diameter of between 1 and 500 μm determined in accordance with ISO 13320; and
forming the graphite-containing molded body into one of a sealing element, a bipolar plate of a fuel cell, a redox flow battery, a heat conduction film, a molded part for use in a construction area, a wall cladding, a ceiling cladding, a heat conduction plate, a current collector in lead acid batteries, a hybrid system, a film or fin in PCM graphite storage devices, a lining material, a contact element, a electrode material for battery systems, a heat distributing element, a surface heater, a material for winding graphite tubes with individual layers being weldable, a stuffing box packing, packings for chemical columns, a heat exchanger plate or a heat exchanger tube.

55. A method of using a graphite-containing molded body, which comprises the steps of:
providing the graphite-containing molded body containing graphite particles, at least one solid additive mixed with the graphite particles to form a mixture, the mixture containing one of at least one inorganic additive, a mixture of at least one inorganic additive and at least one additive, or at least 10 wt. % of an organic additive, the mixture being subsequently compressed, the at least one solid additive having a mean particle diameter of between 1 and 500 μm determined in accordance with ISO 13320; and
joining the graphite-containing molded body to another molded body, wherein the another molded body is selected from the group consisting of a graphite film, a metal film, a metal sheet, a metal block, a textile fabric, and a felt body.

56. The method according to claim 55, which further comprises welding the graphite-containing molded body to the another molded body.
